(19) United States
(12) Patent Application Publication
(10) Pub. No.: US 2008/0277075 A1
(43) Pub. Date: Nov. 13, 2008

(54) Window covering device

(75) Inventor: Li-Ming Cheng, Kaohsiung (TW)

Correspondence Address: Joe McKinney Muncy, PO Box 1364, Fairfax, VA, 22038-1364, US

(73) Assignee: ZIPSHADE INDUSTRIAL (B.V.I) CORP

(21) Appl. No.: 11/798,006

(22) Filed: May 9, 2007

(51) Int. Cl. E06B 9/38

(52) U.S. Cl. 160/167 R

(57) ABSTRACT

A window covering device without cord control comprising a top elongated member, a middle elongated member, a bottom elongated member, a window covering, a middle elongated member controller, a bottom elongated member controller, a window covering is connected between the middle elongated member and the bottom elongated member, the middle elongated member controller is mounted in the top elongated member, with a connection cord extending through the bottom elongated member, the window covering, the middle elongated member, and connected with the top elongated member. The window covering device can be opened from top or from bottom without cord control.

### BACKGROUND OF THE INVENTION

1. Field of the Invention

The present invention relates to a window covering device without cord control, and particularly relates to a window covering device that is mounted in window or French window, and is opened either from top or from bottom without any cord controls.

2. Description of the Related Art

Conventional window covering device only allows the bottom side to rise or descend to open or close the window covering device. However, only the movement of a bottom of the window covering device can not perfectly adjust the in-door brightness.

So window covering devices opened either from top or from bottom are designed, which are most controlled by cords. The controlling cords normally extend out, which are dangerous for children, as the cords may wind a child's neck and threaten his life.

The design of window covering devices without cord control is only applied on bottom-opened window covering devices, but not for the window covering devices opened either from top or from bottom.

Therefore, the invention provides a window covering device to mitigate or obviate the aforementioned problems.

### SUMMARY OF THE INVENTION

The main objective of the present invention is to provide A window covering device without any cord controls.

The window covering device in accordance with the present invention comprises a top elongated member, a middle elongated member, a bottom elongated member, a window covering, a middle elongated member controller and a bottom elongated member controller. The window covering is connected between the middle elongated member and the bottom elongated member, the middle elongated member controller is mounted in the top elongated member with a connection cord extending through the bottom elongated member, the window covering, the middle elongated member, and connected with the top elongated member.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of the window covering device in accordance with the present invention;

FIG. 2 is an operational perspective view of the window covering device in FIG. 1 with the middle elongated member descending;

FIG. 3 is an exploded perspective view of the middle elongated member controller of the window covering device in FIG. 1;

FIG. 4 is a top view in partial section of the middle elongated member controller of the window covering device in FIG. 1;

FIG. 5 is an exploded perspective view of the bottom elongated member controller of the window covering device in FIG. 1;

FIG. 6 is a top view of the bottom elongated member controller of the window covering device in FIG. 5 without the upper case;

FIG. 7 is an operational top view of the bottom elongated member controller of the window covering device in FIG. 6 with the press member pressed;

FIG. 8 is a top view of another bottom elongated member controller of the window covering device in accordance with the present invention;

FIG. 9A is a perspective view of another embodiment of the window covering device in accordance with the present invention;

FIG. 9B is a perspective view of another embodiment of the window covering device in accordance with the present invention; and

FIG. 10 is an exploded perspective view of the bottom elongated member controller shown in FIG. 9A; and

FIG. 11 is a top view of another bottom elongated member controller of the window covering device in accordance with the present invention.

### DETAILED DESCRIPTION OF THE PREFERRED EMBODIMENT

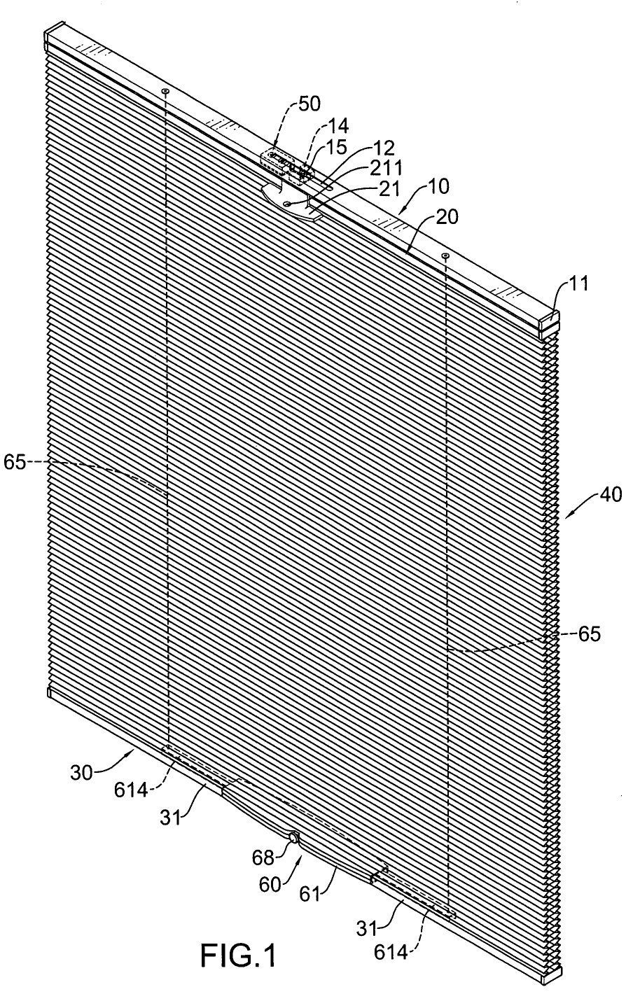

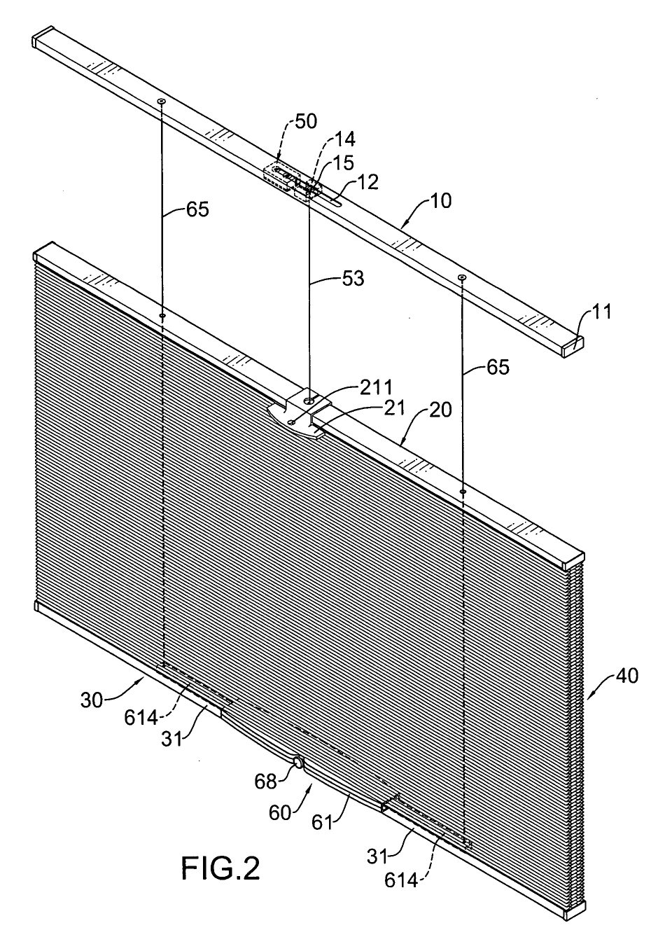

With reference to FIGS. 1-2, a window covering device in accordance with the present invention has a top elongated member (10), a middle elongated member (20), a bottom elongated member (30), a window covering (40), a middle elongated member controller (50) and a bottom elongated member controller (60).

The top elongated member (10), middle elongated member (20), and bottom elongated member (30) are hollow, may be made of plastic material and are arranged in a row, and each of the elongated members (10, 20, 30) has two ends and two caps (11) detachably mounted respectively at the two ends.

The window covering (40) is mounted between the middle elongated member (20) and the bottom elongated member (30).

The middle elongated member controller (50) has no cord controllers and is mounted in the top elongated member (10) to control the rise or descending of the middle elongated member (20).

The bottom elongated member controller (60) has no cord controllers and is mounted in the bottom elongated member (30) to control the rise or descending of the bottom elongated member (30).

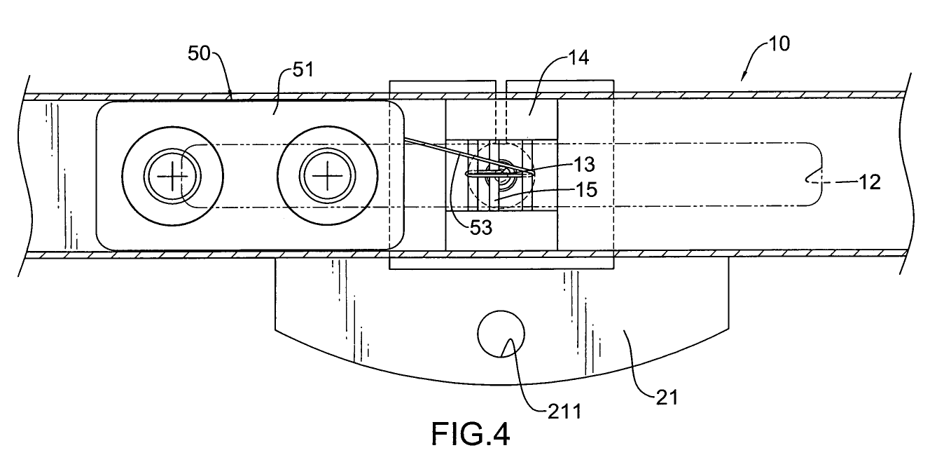

With reference to FIG. 4, the top elongated member (10) has a top, a bottom, a front, at least one through hole (13) defined in the bottom, and a guide wheel seat (14) mounted in the top elongated member (10). The guide wheel seat (14) has at least one guide wheel (15) mounted rotatably on the guide wheel seat (14) in the top elongated member (10). The top elongated member (10) further has a longitudinal hole (12) defined in the top to facilitate the mounting of the middle elongated member controller (50) and the guide wheel seat (14).

With reference to FIGS. 1-2 again, the top elongated member (20) has a pull board (21) formed in the front, which has an orifice (211) defined through the pull board (21) for drawing.

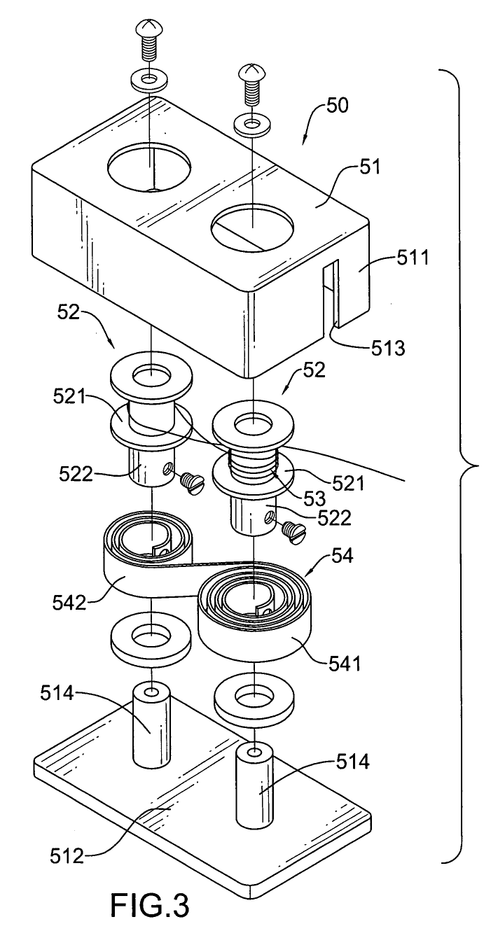

With reference to FIG. 3, the middle elongated member controller (50) has two pivot poles (514), two wind reels (52), a connection cord (53) and a reversible spring (54) and may include a shell (51) in this embodiment.

The shell (51) comprises two sides, an upper case (511) and a lower case (512), and a cord hole (513) is defined through one side.

The two pivot poles (514) are formed on the bottom of the top elongated member (10). In a preferred embodiment, the pivot poles (514) are formed on the lower case (512) and the shell (51) is mounted in the top elongated member (10).

The two wind reels (52) are rotatably mounted respectively on the two pivot poles (514) in the shell (51). Each wind reel (52) has a periphery wall, a round valley (521) defined radially in the periphery wall and a sleeve (522) extending from the wind reel (52).

The connection cord (53) has an end connected with one wind reel (52), winds on the round valleys (521) in the two wind reels (52) along an 8-shaped path, then extends through the shell (51), winds on the at least one guide wheel (15), then is connected to the middle elongated member (20) through the through hole (13). Alternatively, as shown in FIG. 4, the connection cord (53) may be connected to two cords directly or indirectly, then the two cords wind on the at least one guide wheel (15), then are connected to the middle elongated member through the through hole (13).

The reversible spring (54) has two coils (541, 542) formed integrally with each other, and the two coils (541, 542) are mounted respectively around the sleeves (522) and each coil (541, 542) has a distal end. The distal ends of the coils (541, 542) are connected with the sleeves (522).

The bottom elongated member controller (60) in the bottom elongated member (30) has multiple embodiments.

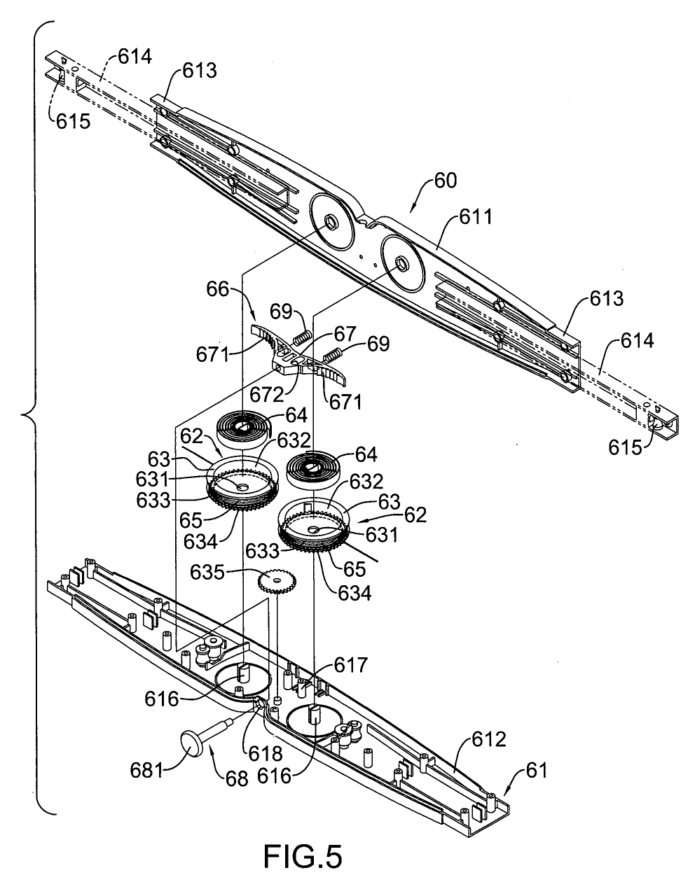

With reference to FIGS. 1 and 5, a first embodiment of the bottom elongated member controller (60) is illustrated. The bottom elongated member (30) is divided into two sub elongated members (31), and the bottom elongated member controller (60) is mounted between the two sub elongated members (31). The bottom elongated member controller (60) has a shell (61), two wind reel groups (62) and a brake (66).

The shell (61) has two ends, an upper case (611) and a lower case (612). Each end of the shell (61) has a hollow connection member (613) to connect with the two sub elongated members (31). The upper case (611) and the lower case (612) are mounted together by screws, engagement, bonding or other connection methods. Each connection member (613) is connected with a guide elongated member (614) extending into one of the sub elongated members (31). A distal end of the guide elongated member (614) has a roller (615). The lower case (612) of the shell (61) has two pivot-poles (616) formed on the lower case (612) and parallel to each other, and at least one limitation pole (617) is mounted on the shell (61) between the two pivot poles (616). A through hole (618) is defined in the shell (61).

The two wind reel groups (62) are mounted in the shell (61), correspond respectively to the pivot poles (616) and each wind reel group (62) includes a wind reel (63), a spiral spring (64) and a connection cord (65). The wind reel (63) are round, is mounted rotatably around a corresponding pivot pole (616) and has a pivot hole (631) through which the corresponding pivot pole (616) is mounted. The wind reel (63) further has a top and a periphery wall, a chamber (632) defined in the top and having an inner wall, and a round valley (633) defined radially in the periphery wall. The spiral spring (64) is mounted securely in the chamber (632) and has an inner end connected with the corresponding pivot pole (616) and an outer end connected with the inner wall of the chamber (632). The connection cord (65) has two ends. One end is connected to the wind reel (63) and winds around the round valley (633). The other end extends through one of the connection members (613) along one of the guide elongated members (614), winds around the roller (615) on the guide elongated member (614), and is mounted through the bottom elongated member (30), the window covering (40), the middle elongated member (20) then is connected to one end of the top elongated member (10).

The wind reel groups (62) are further engaged with a gear (635) mounted pivotally in the shell (61) between the two wind reels (63). Each wind reels (63) has a gear portion (634) formed radially on the wind reel (63) and engaged with the gear (635). Thus the two wind reels (63) rotate simultaneously.

The brake (66) is mounted in the shell (61) and includes a brake stop (67), a press member (68) and at least one elastic member (69). The brake stop (67) is mounted in the shell (61) and has two curved pawls (671) formed at two sides, at least one longitudinal hole (672) defined through the brake stop (67). The limitation pole (617) is mounted in the longitudinal hole (672). The two curved pawls (671) abut the wind reels (63). The press member (68) has a button (681) extending out of the shell (61) and connected with the brake stop (67) through the through hole (618) in the shell (61). The at least one elastic member (69) is connected to the brake stop (67) and the shell (61) to provide an elastic force so that the two curved pawls (671) abut the two wind reels (63) to prevent the rotation of the wind reels (63).

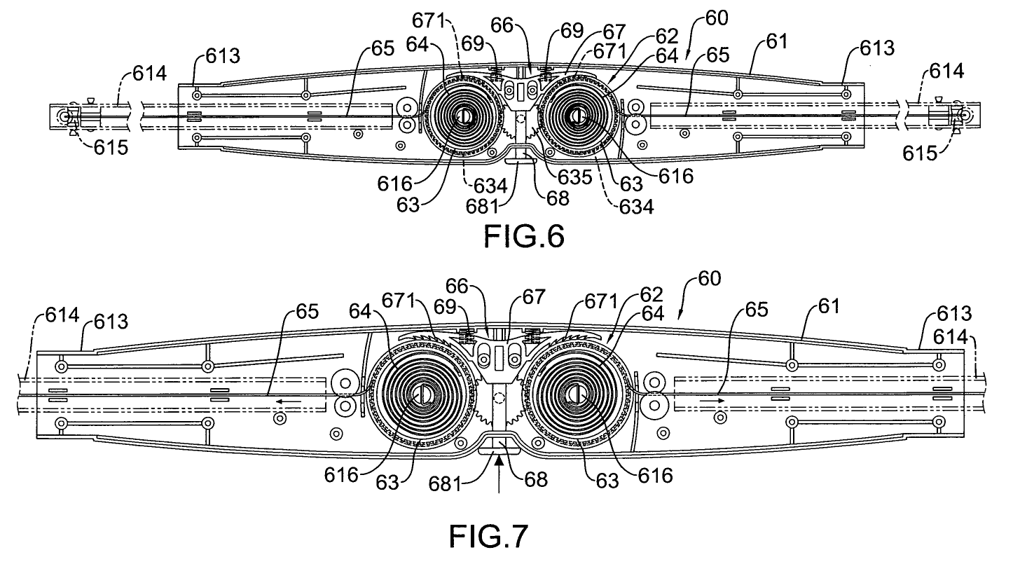

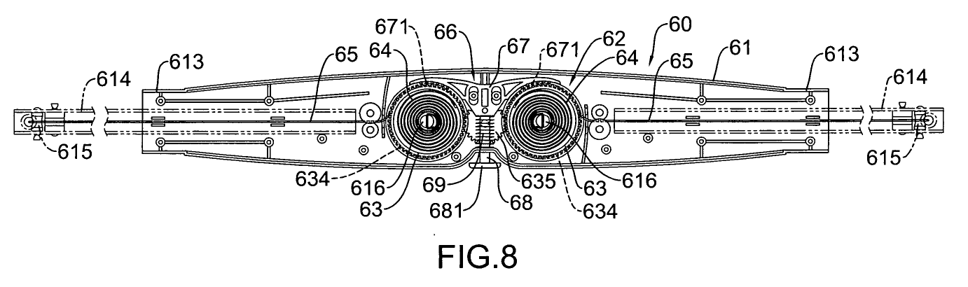

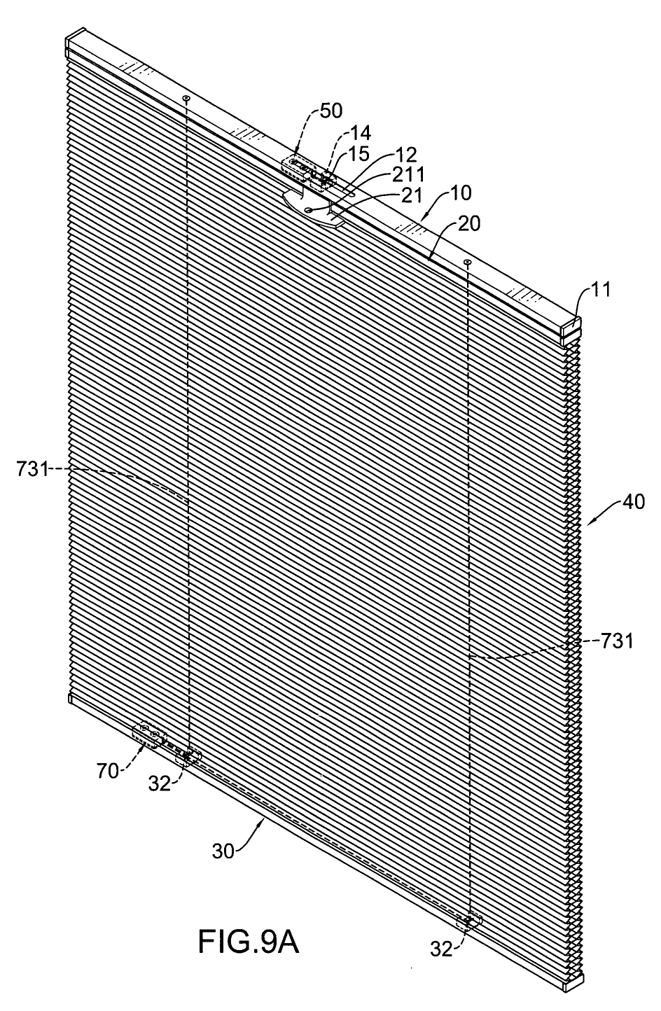

The brake (66) may have two elastic members (69), as shown in FIGS. 5-7, which are compression springs and each compression spring is connected between one of the curved pawls (671) and a back wall of the shell (61). Alternatively, as shown in FIG. 8, the brake (66) has only one elastic member (69), which is a tension spring. The tension spring is mounted around the press member (68) and is mounted securely between the brake stop (67) and a front wall of the shell (61).

The top elongated member (10) is fixed on the windows by multiple connection seat. When the press member (68) is pressed, the two wind reels (63) disengages from the two curved pawls (671). At this time, the bottom elongated member (30) is pulled down to spread the window covering (40). When the window covering spreads to a certain position, the press member (68) is released, the two curved pawls (671) again abut the two wind reels (63) and stop the rotation of the wind reels (63) to keep the bottom elongated member (30) at the certain position. When the bottom elongated member (30) is needed to rise, the operation steps are similar to the above steps, the bottom elongated member (30) is pushed up, and the window covering rises to fold.

In addition, when the window covering (40) spreads out, the window covering (40) can be lowered down by controlling the middle elongated member controller (50). Users can pull the middle elongated member (20) as well as the window covering (40) down through the pull board (21). When the middle elongated member's descending (20) make the two wind reels (52) in the middle elongated member controller (50) to rotate simultaneously to release the connection cords, meanwhile, one coil (541, 542) of the reversible spring (54) is released, and the other coil (541, 542) is tense to keep a balance force. When the middle elongated member (20) is in a certain position, the reversible spring (54) provide an elastic force, which is equal to a weight of the middle elongated member (20) and the window covering (40), and the middle elongated member (20) is kept in the certain position. When the middle elongated member (20) is needed to rise, the operation steps are similar to the above steps, and the middle elongated member controller (20) is pushed up. In this way, the window can be opened from bottom or from top.

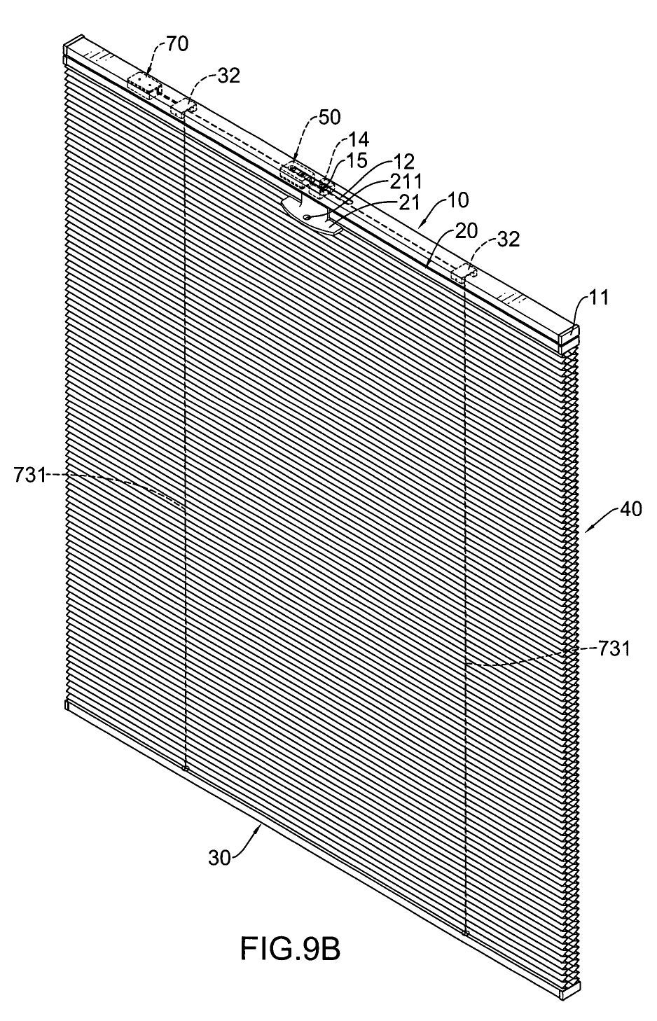

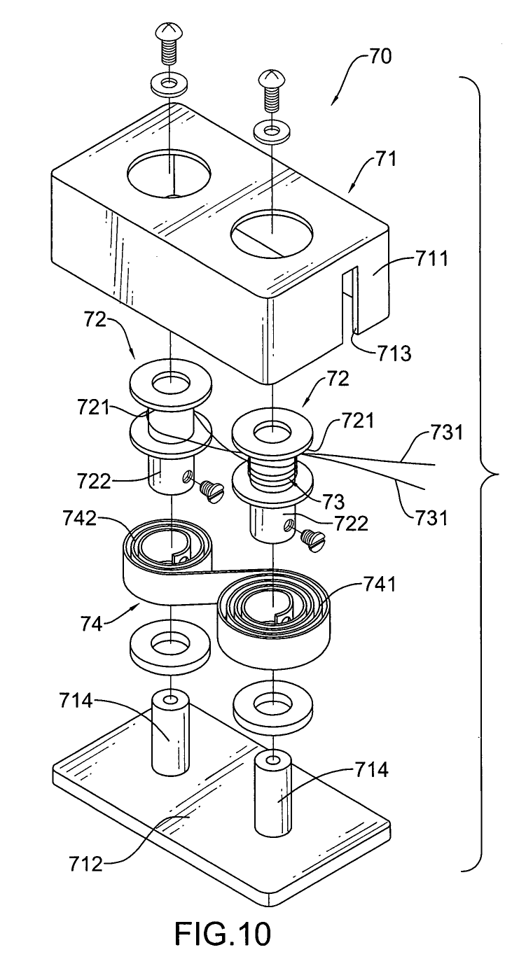

With reference to FIGS. 9A and 10, it is another embodiment of the bottom elongated member controller (70). The bottom elongated member (30) is a single elongated member and two rollers (32) are mounted in the bottom elongated member (30). The bottom elongated member controller (70) is mounted in the bottom elongated member (30) and includes a top, a bottom, a front, two pivot poles (71), two wind reels (72), a connection cord (73) and a reversible spring (74) and may have a shell (71).

The shell (71) comprises two sides, an upper case (711), a lower case (712), and a through hole (713) is defined in the shell (71).

The two pivot poles (714) are formed in the bottom of the bottom elongated member (30). In a preferred embodiment, the pivot poles (714) are formed on the lower case (712) of the shell (71) then the shell (71) is mounted in the bottom elongated member (30).

The two wind reels (72) are rotatably mounted respectively on the two pivot poles (714). Each wind reel (72) has a periphery wall, a round valley (721) defined radially in the periphery wall and a sleeve (722) extending from the wind reel (72).

The connection cord (73) has an end connected to one wind reel (72), and wind on the round valleys in the wind reels (72) along an 8-shaped path. The connection cord (73) is connected with two cords (731) directly or indirectly. The cords (731) wind respectively through the rollers (32) in the bottom elongated member (30), then are connected with the top elongated member (10) through the bottom elongated member (30), the window covering (40), and the middle elongated member (20).

The reversible spring (74) has two reverse coils (741, 742) formed integrally with each other, and the two coils (741, 742) are mounted respectively around the sleeves (722) and each coil (541, 542) has a distal end. The distal ends of the coils (741, 742) are connected with the sleeves (722).

When the above embodiment of bottom elongated member controller (70) is applied in the window covering device of this invention, user can pull the bottom elongated member directly. Meanwhile, the connection cord (73) in the bottom elongated member (30) is stretched. Meanwhile, the two wind reels (72) are revolving to release the connection cord (73), and one coil (741) of the reversible spring (74) is released, and the other coil (742) is tense, to keep a balance force. When the bottom elongated member (30) comes to a certain position, the reversible spring (74) provide an elastic force, which is equal to the weight of the bottom elongated member (30) and part of the window covering (40). When the bottom elongated member (30) is needed to rise, the operation steps are similar to the above steps, and push the bottom elongated member (30), and the window covering (40) will rise to fold.

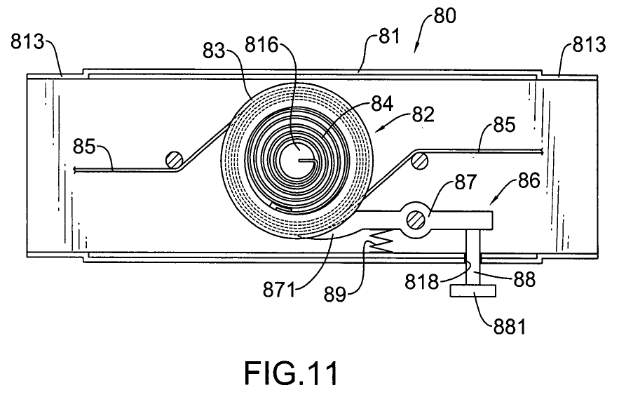

With reference to FIG. 11, it is a third embodiment of the bottom elongated member controller (80), which is mounted between two sub elongated members (31), and includes a shell (81), a wind reel group (82) and a brake (86).

The shell (81) comprises two sides, an upper case and a lower case, and has two hollow connection member (813) formed respectively at the two sides and connect respectively with two sub elongated members (31). The shell (81) has a pivot pole (816) formed in the shell (81) and a through hole (818) defined through the shell (81).

The wind reel group (82) is mounted in the shell (81), includes a wind reel (83), a spiral spring (84), and two connection cords (85). The wind reel (83) is mounted rotatably around the pivot pole (816), and the spiral spring (84) is mounted securely in the wind reel (83) and has two ends connected respectively with the pivot pole (816) and the wind reel (83). Each of the two connection cords (85) has one end connected to the wind reel (83). The two connection cords (85) wind around the wind reel (83), and extend respectively out of the hollow connection members (813), the bottom elongated member (30), the window covering (40), the middle elongated member (20), and connect respectively to the two ends of the top elongated member (10).

The brake (86) is mounted in the shell (81), includes a brake stop (87), a press member (88), and an elastic member (89). The brake stop (87) is mounted pivotally in the shell (81) and has two ends, and a curved pawl (871) is formed on one end of the brake stop (87) and abutting the wind reel (83). The press member (88) has a button (881), extends out of the shell (81), and is connected with the brake stop (87) through the through hole (818) in the shell (81). The elastic member (89) is mounted between the brake stop (87) and the shell (81) to provide an elastic force, so that the curved pawl (871) abuts the wind reel (83) to prevent the wind reel from revolving.

When the third embodiment applied on the window covering device of the present invention, the press member (88) is pressed, and the two curved pawls (871) disengages from the wide reels (83). Meanwhile, the bottom elongated member (30) is pulled down and the blind (40) spread. When the bottom elongated member (30) comes to a certain position, the press member (88) is released, and the curved pawl (871) abuts the wind reel (83) again to prevent the wind reel (83) from rotating, and the bottom elongated member (30) will stay at the certain position. When the bottom elongated member (30) is needed to rise, the steps are similar to the above steps, and the bottom elongated member (30) is pushed up and the window covering (40) is folded.

With reference to FIG. 9B, an embodiment of the window covering device is similar to the embodiment in FIG. 9A and has the bottom elongated member controller (70) and the rollers (32) mounted in the top elongated member (10). The cords (731) connecting with the third connection cord (73) wind respectively through the rollers (32), extends through the top elongated member (10), the window covering (40) and the middle elongated member (20) and then connect securely with the bottom elongated member (30).

The window covering device is operated without any cord controls so children would be safe when playing near the window covering device.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A window covering device comprising a top elongated member, a middle elongated member, a bottom elongated member, a window covering, a middle elongated member controller and a bottom elongated member controller; wherein:
the window covering is mounted between the middle elongated member and the bottom elongated member;
the middle elongated member controller is mounted in the top elongated member and has two pivot poles mounted on the top elongated member and two wind reels respectively mounted rotatably around the two pivot poles, and each two wind reel having a round valley defined radially in the wind reel;
a connection cord has an end connected to one of the wind reels, winds on the round valleys in the two wind reels, then extends through the top elongated member and is connected to the middle elongated member; and
a reversible spring has two reverse coils formed integrally with each other, and the two coils are mounted respectively around the wind reels.

2. The window covering device as claimed in claim 1, wherein the connection cord is connected to two connection cords and connected to the middle elongated member through the top elongated member.

3. The window covering device as claimed in claim 1, wherein the middle elongated member controller has a shell with a through hole defined through the shell, the pivot poles, the wind reels, and the reversible springs are mounted in the shell, the connection cord extends through the through hole in the shell and the top elongated member and is connected with the middle elongated member.

4. The window covering device as claimed in claim 1, wherein the top elongated member is hollow, is made of plastic material and has a top, a bottom and a front, a through hole is defined in the bottom, and at least one guide wheel is mounted in the top elongated member, the connection cord winds on the at least one guide wheel, and is connected with the middle elongated member through the top elongated member.

5. The window covering device as claimed in claim 1, wherein the bottom elongated member controller is mounted in the bottom elongated member, and comprises:
a shell having two ends, an upper case and a lower case, the lower case of the shell having two pivot poles being parallel to each other;
two wind reel groups mounted in the shell of the bottom elongated member controller, corresponding respectively to the pivot poles and each wind reel group including
a wind reel mounted rotatably around a corresponding pivot pole in the shell and has a round valley defined radially in the wind reel;
a spiral spring mounted securely in a chamber in the wind reel and having an inner end connected with the corresponding pivot pole and an outer end connected with the wind reel; and
a connection cord having two ends, one end connected to the wind reel, winding around the round valley, and the other end of the connection cord extending through the bottom elongated member, the window covering, the middle elongated member then connected to the top elongated member;
a brake mounted in the shell of the bottom elongated member controller and including a brake block, a press member and at least one elastic member, the brake block mounted in the shell and having two curved pawls formed at two sides, one end of the press member extending out of the shell and the other end connected with the brake block, the at least one elastic member connected to the brake block and the shell to provide an elastic force.

6. The window covering device as claimed in claim 5, wherein the brake has the at least one elastic member being two compression springs connected to the brake block and the shell.

7. The window covering device as claimed in claim 5, wherein the brake has the at least one elastic member being a single spring connected to the brake block and the shell.

8. The window covering device as claimed in claim 5, wherein the bottom elongated member is divided into two sub elongated members, each end of the shell having a hollow connection member to be connected with one of the two sub elongated members, each connection member is connected with a guide elongated member extending into one of the two sub elongated members.

9. The window covering device as claimed in claim 5, wherein the wind reel group further has a gear pivotally mounted in the shell of the bottom elongated member controller, between the two wind reels, each wind reel further has a gear portion mounted on the wind reel and engaged with the gear.

10. The window covering device as claimed in claim 1, wherein the bottom elongated member controller is mounted in the bottom elongated member, and includes two pivot poles, two wind reels, a connection cord, and a reversible spring;
the two pivot poles are formed in the bottom elongated member;
the two wind reels are rotatably mounted respectively around the two pivot poles, each wind reel has a round valley defined radially in the wind reel, and a sleeve extends from the wind reel;
the connection cord has an end connected to one wind reel, winds around the round valleys in the two wind reels, the connection cord is connected with the top elongated member through the bottom elongated member, the window covering and the middle elongated member; and
the reversible spring has two reverse coils formed integrally with each other, and the two coils are mounted respectively around the sleeves, each coils has a distal end and the distal ends of the coils are connected with the sleeves.

11. The window covering device as claimed in claim 1, wherein the connection cord is connected to two cords, then the two cords wind at least one guide wheel mounted in the top elongated member, then are connected to the middle elongated member through a through hole defined through the top elongated member.

12. The window covering device as claimed in claim 1, wherein the bottom elongated member controller comprises:
a shell having two ends, an upper case and a lower case, the lower case of the shell having two pivot poles parallel to each other;
two wind reel groups mounted in the shell of the bottom elongated member controller, corresponding respectively to the pivot poles and each wind reel group including
a wind reel mounted rotatably around a corresponding pivot pole in the shell and has a round valley defined radially in the wind reel;
a spiral spring mounted securely in a chamber in the wind reel and having an inner end connected with the corresponding pivot pole and an outer end connected with an inner wall of the chamber; and
a connection cord having two ends, one end connected to the wind reel, winding in the round valley, and the other end of the connection cord extending through the bottom elongated member, the window covering, the middle elongated member then connected to the top elongated member;
a brake mounted in the shell of the bottom elongated member controller and including a brake block, a press member and at least one elastic member, the brake block mounted in the shell having two curved pawls formed at two sides, the elastic member providing the curved pawls with an elastic force to abut the wind reels, the press member driving the curved pawls away from the wind reels.

13. The window covering device as claimed in claim 1, wherein the bottom elongated member controller comprises:
a shell having an upper case and a lower case, the lower case of the shell having a pivot pole;
a wind reel group mounted in the shell and including a wind reel, a spiral spring and at least one connection cord, the spiral spring mounted securely in the wind reel, and having two ends connected respectively to the pivot pole and the wind reel, one segment of the connection cord connected to the wind reel and winding around the wind reel, and at least one end of the connection cord extending through the bottom elongated member, the window covering, the middle elongated member then connected to the top elongated member;
a brake mounted in the shell and including a curved pawl, a press member and an elastic member, the elastic member providing the curved pawl with an elastic force to abut the wind reel, the press member driving the curved pawl away from the wind reel.

14. The window covering device as claimed in claim 1, wherein the middle elongated member has a pull board.

15. The window covering device as claimed in claim 10, wherein the middle elongated member has a pull board.

16. The window covering device as claimed in claim 12, wherein the middle elongated member has a pull board.

17. The window covering device as claimed in claim 5, wherein the middle elongated member has a pull board.

18. The window covering device as claimed in claim 1, wherein the bottom elongated member controller comprises:
a shell having two ends and each end having a hollow connection member, a pivot pole formed in the shell and a through hole defined through the shell;
a wind reel group mounted in the shell and including a wind reel, a spiral spring and two connection cords, the spiral spring mounted securely in the wind reel, and having two ends connected respectively to the pivot pole and the wind reel, each connection cord having two ends, one end of the connection cord connected to the wind reel and winding around the wind reel, and the two connection cords extending respectively through the top elongated member, the middle elongated member, the window covering then connected respectively to the two ends of the bottom elongated member;
a brake mounted in the shell and including a brake stop, a press member and an elastic member, the brake stop having two ends and a curved pawls formed on one end of the brake stop, the press member having a button, extending out of the shell and connected with the brake stop through the through hole in the shell, the elastic member mounted between the brake stop and the shell to provide an elastic force.
